(19) United States
(12) Patent Application Publication
(10) Pub. No.: US 2015/0110319 A1
(43) Pub. Date: Apr. 23, 2015

(54) Earring Hearing Aid

(71) Applicant: Dawn Mimbs, Charlotte, NC (US)

(72) Inventor: Dawn Mimbs, Charlotte, NC (US)

(21) Appl. No.: 14/340,513

(22) Filed: Jul. 24, 2014

Related U.S. Application Data
(60) Provisional application No. 61/958,401, filed on Jul. 29, 2013.

(51) Int. Cl. H04R 25/00

(52) U.S. Cl. CPC H04R 25/60; H04R 2225/025
USPC 381/322

(57) ABSTRACT

The advantage of the present invention over prior know hearing aid devices are that it is a complete hearing aid which is worn as jewelry, thus not giving any indication that it is a hearing aid. The Earring Hearing Aid offers women, men and children a hearing aid that is aesthetically beautiful as jewelry that functions with the latest technology. The ornamental hearing aid is attached to the user's lower earlobe and also offers different techniques of ware such as, a clamp on style that fits over the cartilage at the entrance to the ear canal. All styles provided in this invention can be attached via piercings, via ear lobe clip or clamp on technique, or other methods. All Hearing Aids offer attachments of ornamental jewels that attach to the main body of the earring hearing aid and come in several colors for desired wearing attire. The hearing aid is composed of a main body, which connects to the receiver located down in the ear canal via a plastic tube and proper wire connection, and could be fiber optic as well. However the future is going to a new technology where every component could be housed in the main unit with wireless power transmissions that use engineered phrased array antennas to focus a beam of microwaves to a receiver module which can deliver electrical power from a central transmitter. Therefore eliminating the need to charge the battery continuously. Charger automatically locates receiver built in devices or batteries, these signals follow same path of the receiver focusing energy to the devise. The Earring Hearing Aid is adaptable for all energy sources as well as any future power energy source. Such as solar, magnetic, radiation, and micro waves. Design can be offered and developed in other shapes and the mechanical components could also be housed in the attachments as well.

Earring Hearing Aid Description: The advantages of the present invention over prior known hearing devices is that it embodies the function of the hearing aid, while offering the aesthetic beauty of the ornamental jewelry which comprises the actual hearing aid components. The components could be housed in the attachments as well, whether the attachments are dangling or otherwise transfixed to original post fixture, via wire design, clip on style, as well as clamp or clasp on method, while being attached to the lower portion of the earlobe. The main hearing aid base design, could be orchestrated to be round, oval, square, oblong or other variations in design. Also the dangling attachment can be in different shapes as well. The Earring Hearing Aid can be worn on one or both ear lobes. It is designed for Women, Men and Children, to offer style as an ornament while not giving any indication that it is a hearing aid, to provide amplified sound for the purpose of the loss of the individual's hearing.

The present invention is designed to be integrated with the latest developments in technology and engineering of energy and any unique power source, whether it is through electrical, wireless power transmission using a beam of phased array microwaves to a receiver module of electrical power from a central transmitter. Charger automatically locates the receiver built in batteries or devises, focusing energy at the exact location of the devise, making it possible to stay in a state of permanent full charge technique sent through unidirectional signals.

Also the Earring Hearing Aid is designed to be integrated to any engineered source of energy whether it is fiber optic, solar, electrical, magnetic, battery, microwave, radiation, or any other means to function, and be concealed within the Earring Hearing Aid Components are developed on a smaller level such as minute microscopic chips that are constantly being innovated. Therefore this design can be adapted to any and all energy sources.

The Earring Hearing Aid Description functions as camouflaging the appearance of a hearing aid. As so many people, interpret hearing aids as a sign of age. And they will go to extremes to deny hearing loss. Most people will camouflage a hearing aid at all cost. The present invention offers several options for design as well as latest technical development and future energy source that are being developed in the last 2 years.

Energy and power are constantly being developed, therefore this invention is adaptable for the latest in technology as well as the future resources on The New Horizon which I have done research on.

There are many hearing aids worn by infants that are huge and bulky, unbearably uncomfortable. Over powering the infants tiny head frame and ear.

For them to lie in bed and wear such an appendage is appalling. This offers comfort and a much smaller devise that is very attractive and a welcome for anyone that suffers from hearing loss. Over the years engineers have developed smaller and smaller components that make up a hearing aid. They have become micro tiny chips housed in the hearing aids. All though there are hearing aid implants, some people will never except a hearing aid implant placed beneath their skin in the canal of the ear. They simply will not accept the concept of an implant and do not desire any surgical technique to be performed in any fashion.

Most hearing aids that are on the market that the general public can afford are too large and worn behind the ear, or right in the opening of the ear canal, which are large and visible.

The advantage of this invention of the Earring Hearing Aid is that it is beautiful and could be affordable for all parties that desire an option to appear like they do not have an issue with hearing loss.

Also this invention offers several options in design and wear of the hearing aid. As well as being adaptable to the latest in technology and energy source.

Hearing Aids come in three types (BTE) behind the ear (ITE) in the ear (CIC) completely in the canal of the ear as well as implants that are implanted through a surgical technique.

There are many types of hearing aids on the market; however most are large and unattractive. The (BTE) can constantly fall forward and feels very uncomfortable when wearing for several hours. The component that fits inside the opening of the canal causes your ears to sweat. Also if you wear these long enough it will cause the ears protrude permanently as all of our body parts have a memory, thus the redundancy of having them on all the time makes our own ear stick out in time. They are also painful and very uncomfortable when we place a pillow behind.

The (ITE) has to be custom fit and may come in colors as well as flesh tone. It was developed to be a smaller alternative and to offer some style as the choice of color. However it Is still visible.

The (CIC) U.S. Pat. No. 6,228,020 Is custom molded to fit within the canal of the patient or customer's ear's. It was developed to conceal the hearing aid and stayed in place because it conformed to the individual's own ear canal anatomy.

U.S. Pat. No. 5,533,130(A) conceals only half the ear and was designed for eyeglasses.

U.S. Pat. No. 2,909,619(A) large components and bulky apparatus

U.S. Pat. No. 5,365,593(A) is not concealed, and large at canal entrance

U.S. Pat. No. 4,672,672 enlarged volume control and not decorative.

U.S. Pat. No. 2,909,619 shows a decorative advice that is clipped to the outside of hearing aid case. The volume control projects from behind the decorative devise and is still large.

Although hearing aid manufactures have responded by offering smaller devices and a color range, they still are visible when looking near the canal opening of the ear.

There is a whole new audience screaming for the need of a hearing aid that does not look like the hearing aids that are presently offered on the market.

The present Invention which I have developed, The Earring Hearing Aid is more adaptable to latest technology and the future of technology and offers more variety in designs, and is far more attractive than pervious inventions of ornamental hearing aids. The Earring can house the main components such as: the speaker, microphone, amplifier, and volume control; where as it is incorporated in the housing of the stud or solitaire gemstone, fabricated or genuine, within the body of the earring itself. It can also be housed in the dangling ornamental attachment. Volume control can be touch technique or rotating technique. The receiver is attached to plastic tube that is in the canal of the ear. Transmitted through a wire housed in the tube or fiber optic that is housed in the tube which connects to the earring and guided into the canal of the ear. This is a very flexible tube that molds to any one's ear canal.

As technology continues to develop there may be no need for a tube and possibly all micro components can be housed and function in a single unit orchestrated within the entire earring so that the receiver is also contained or attached to the unit as a whole entity.

Some hearing aids already house all components in a single unit; they are the hearing aids that fit in the ear canal. Some come in a variety of colors as well as they offer a flesh color and most are custom fit for the customer's use.

Certainly this invention leads the way for just that purpose.

Brief Description

### BRIEF DESCRIPTION OF DRAWINGS

FIG. 1 Depicts side view of solitaire earring hearing aid, from top to bottom, showing components housed within unit

FIG. 2 Is detail of front view of the solitaire earring hearing aid and placement on ear lobe.

FIG. 3 Depicts side view of solitaire earring hearing aid attached to the earlobe and entrance to the ear canal.

FIG. 4 Detail of side view of flexible decorative metallic coil overlapping plastic tube that travels into the ear canal.

FIG. 5 Side view of post solitaire earring hearing aid, with post fitting and totally self contained components housed within the earring.

FIG. 6 Side view of clasp or clip on style solitaire earring hearing aid with flexible metallic coil with clear plastic tube conductor.

FIG. 7 Side view of solitaire earring hearing aid with clip on clasp housing all the mechanical components within the single unit.

FIG. 8 Front view of earring hearing aid with dangling decorative attachment.

FIG. 9 Front view of dangling attachment with hook that clips on to main body of solitaire.

FIG. 10 Front view of jeweled attachment that is incased in decorative border, detailing the decorative loop and hook that attaches to main solitaire.

FIG. 11 Complete side view of solitaire and dangling attachment with small receiver attached to clear plastic tube that houses wire to transfer sound.

FIG. 12 depicts Hoop style Earring hearing aid.

FIG. 13 Front and side detail of clamp on style earring hearing aid of flexible metallic metal finish, that clamps over the cartilage just above ear lobe.

FIG. 14 Details clear plastic tube that is attached to back of earring hearing aid and wraps around the back of the ear with in the crease behind the ear and enters from the front and fits down into the ear canal.

### FULL DESCRIPTION

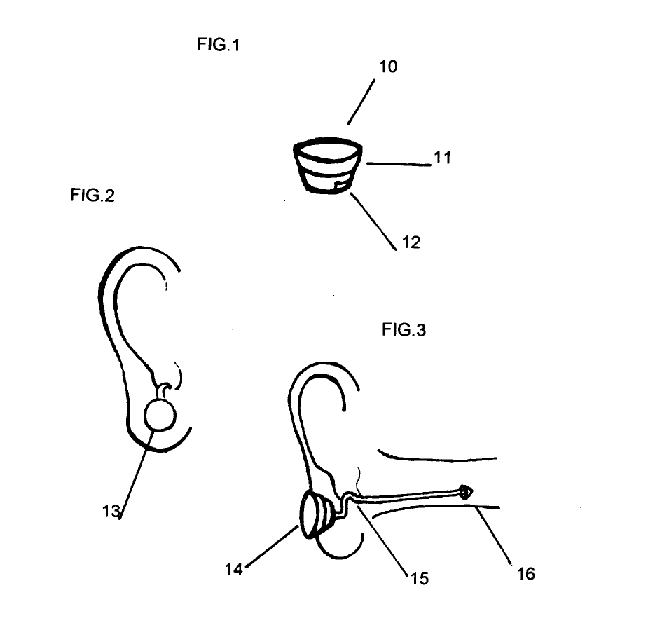

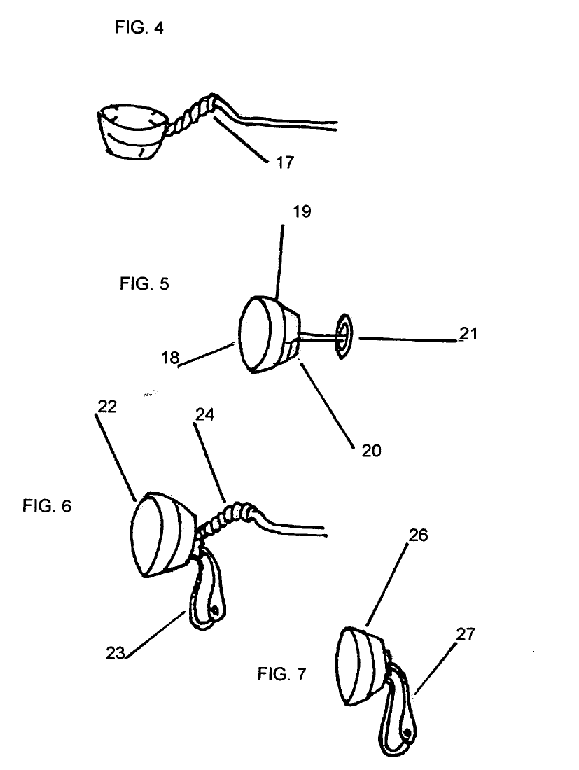

Detail FIG. 1 of Pg. 1 Detail view of top to bottom of the Earring Hearing Aid, can be adapted for pierced ear lobe or lobes which are worn at the perforated site of the lower earlobe (10) Shows stone whether it is genuine, semi precious, fake, and made of crystal or glass. (11) Volume control can rotate or be touch control adjusted from minimum to maximum (12) houses the battery charger could be developed for solar energy as well as wireless micro technology. Also the amplifier can be housed in the body of ear ring. FIG. 2 of Pg. 1 (13) demonstrates where the hearing aid would be placed on earlobe. The hearing aid could be made larger if needed. FIG. 3 of Pg. 1 (14) The stone embellishment that camouflages the components which are incased within the unit of the hearing aid. (15) Decorative coil that is very flexible and conforms to the individual anatomy of the ear, and the amplifier can be housed in the gold decorative coil that is around the plastic tube that is engineered to carry amplified sound to the receiver located in the ear canal. Plastic casing is flexible and could house wire or fiber optic for transferring delivery of sound to the receiver. Amplifier can be in either area of the main body as well as the coil that is attached to the main body. (16) Is tiny dome shaped receiver that is attached to sound conducting tube. FIG. 4 of Pg. 2 two (17) Is flexible gold or platinum color coil which is able to bind and conform to entrance of the ear canal. The plastic sound conducting tube is attached and fits inside of decorative coil. The outer portion of decorative coil can house the amplifier.

FIG. 5 of Pg. 2, Details side profile and view of pierced Earring Hearing Aid which can be attached by post or wire technique (18) Jewel stone embellishment can be solitaire cubic zirconium, crystal, glass, or genuine gemstone, as well as solid gold or silver adornment. (19) Volume control whether it rotates and turns or is touch sensitive from minimum to maximum audio sound (20) battery charger opening with in the base of the solitaire shaped hearing aid (21) snap friction tension back, that adjust to individuals size or thickness of their ear lobe while fitting tightly, and directly onto the metal post. FIG. 6 of Pg. 2, Illustrates side view of Earring Hearing Aid (22) Stone or jewel that camouflages the housing of the hearing aid and components.(23) Clasp or clip on back that is attached to hearing aid which can have the option of a screw on technique as well as adjust to the desired tightness and fit for the security of the apparatus, while offering the patient or customer another option of ware, that offers comfort and style while offering the security of the placement of the hearing aid. (24) shows decorative coil that has a plastic tube attached within the coil. Which transfers the amplified sound from the amplifier or microphone, via wire or fiber optic within the tube to be transmitted to the receiver located at the end of the tube within the ear canal.

FIG. 7 of Pg. 2, (26) Drawing shows side view of main body of the Earring Hearing Aid, which can house all components for the function as the Earring Hearing Aid, as it is possible for engineers to develop all the components in main body as well. (27) is snap on clasp for the person that does not desire pierced earring method,

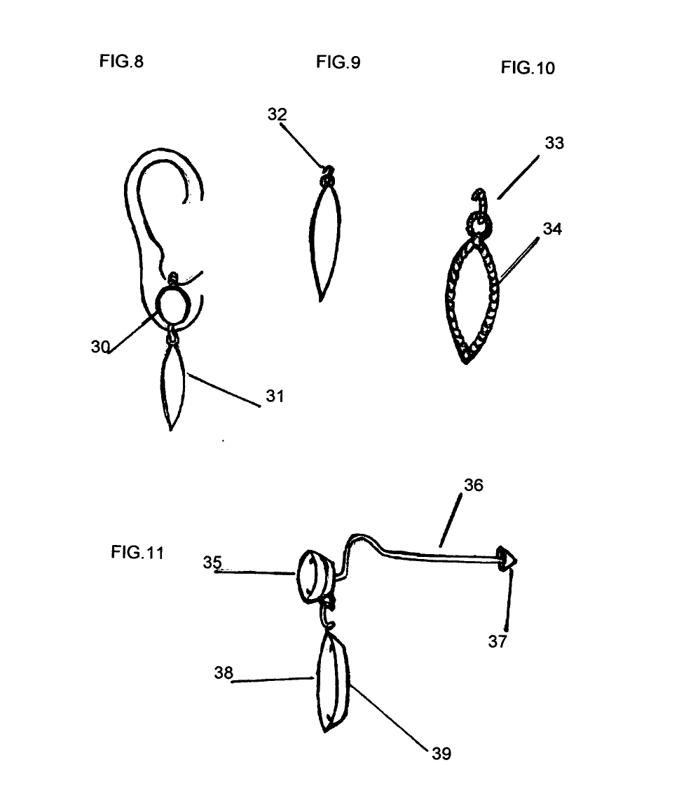

FIG. 8 of Pg. 3, (30) shows the detail of the front view of the solitaire Earring Hearing Aid with dangling ornamental attachments. (31) The Dangling Attachments could also house the main components to function as the hearing aid as well. They can be comprised of several inter changeable crystal, or glass Jewels, The dangling ornament attaches to the bottom of the solitaire through a metal hook on clip or a devise that snaps in place, or through a mounted hook that fits through an opening which could be circular or otherwise. The point is to offer a set of attachments in different colors so that individual has a choice of which color he or she desires to ware as to coordinate with their attire for that day. Therefore the client will not become bored and frustrated with same design, as it offers options of color and style of ware. FIG. 9, Pg. 3 (32) Details dangling attachment marquee shaped with hook for attachment.

FIG. 10, of Pg. 3. (33) jeweled decorative encasement hook for attachment to center stone and base. (34) details decorative encasement of center stone which is marquise shape and could be engineered to perform all necessary elements to function as the hearing aid such as incorporating the touch-sensitive input switch, including the battery to power the hearing aid, as well as the antenna for wireless, electronic communication, could house the microphone receive as well. It could be made In a variety of shapes, such as square, pear, shape, oval, oblong baguette as well as others. It is more conducive to choose one style for the purpose of manufacturing, as it is cost prohibitive. The invention lends it's self towards the rendering of FIG. 8 Pg. 3 of drawings.

FIG. 11 of Pg. 3 (35) Represents the solitaire hearing aid Which is for pierced ear lobe or clip on style, as well as wire technique that penetrates through small hole in the lower ear lobe. (38) Decorative stone, whether genuine or faux in marquise design could be designed to be touch-sensitive, (39) Side profile view of encasement that could also house all necessary components of operation for Earring Hearing Aid such as microphone amplifier, volume control, touch sensitive switch or wireless engineered technique or just be the decorative attachment for the desire of color and different style, to co-ordinate with dress attire. Battery charger could be installed in the back of the dangling attachment as well as in the main body of solitaire which attaches to the ear lobe. (36) Coiled plastic tube that houses the wire or fiber optic that transfers sound to the receiver. (37) Tiny micro dome receiver that is attached to the plastic tube that transfers sound to the receiver.

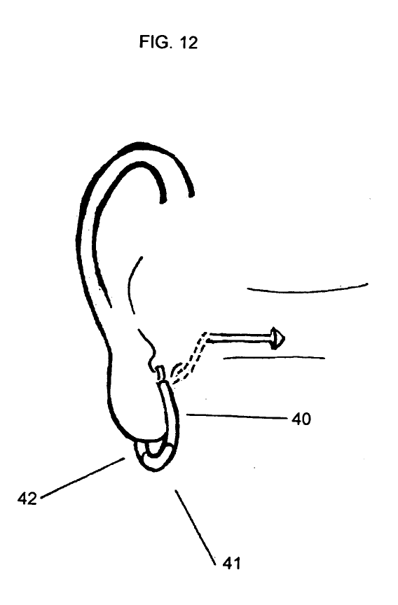

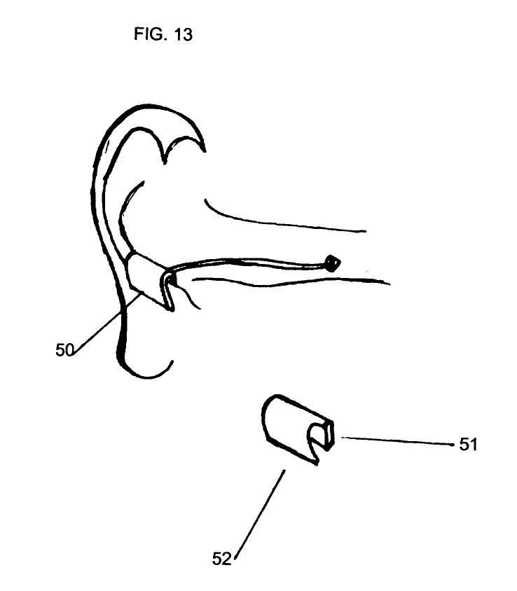

FIG. 12 of Pg. 4 Details of hoop version of Earring Hearing Aid. The hoop earring is another style offered to house the components which make up the function of a hearing aid. It basically just offers another style. (40) Volume control could be touch sensitive or rotate to left or right, depending how it is engineered for maximum or minimum control. (41) microphone components (42) Would house amplifier and battery. All components can be reversed in order depending on Manufacture.

Wire post that penetrates the ear lobe for proper ware and security of stability while snapping in place behind the ear lobe. (41) The battery charger contact.

This Earring Hearing Aid known as a hoop can be engineered best through the Techs advice, as to where the components are housed. It can also be offered in a larger scale and size, as well as width could be increased to house components efficiently. Most Men ware a pierced post solitaire style now.

FIG. 13 Pg. 5 (50) Details clamp on type of earring hearing aid that is constructed of a very flexible metal or metallic finish that conforms to the individual ear and is worn at the sight of the outer ear cartilage just above the ear lobe. (51) Is side view of the inside earring hearing aid that could house battery charger or other components necessary for the function as a hearing aid as well. (52) is flexible metallic finish whether gold or silver as well as containing decorative elements that would mold to patents ear cartilage. Microphone, amplifier, and volume control could be housed within in the outer flexible clamp.

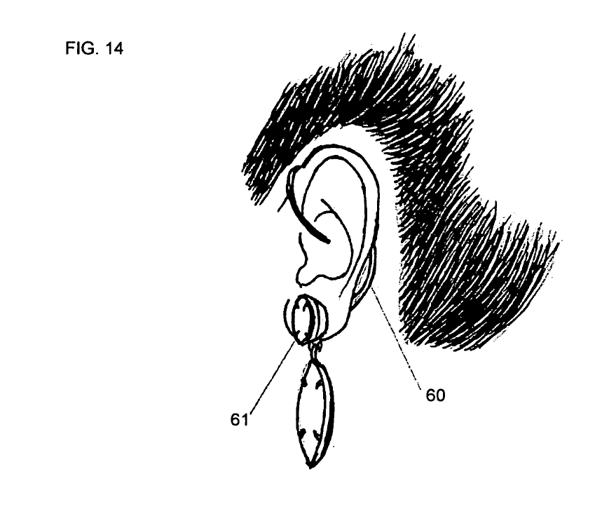

FIG. 14 Pg. 6 (60) Details plastic case which wraps around the back of the ear within the crease behind the ear and enters the top potion of the ear and travels down to the inside of ear canal. Sound is transmitted to the receiver located in the ear canal, This depicts the tube that is attached to the back of post pierced earring hearing aid or can attach to clamp on style as well. It Is very hard to see as it blends in with natural skin tone, (61) Is main component that houses the microphone, amplifier, and volume control as pervious explained in the first renderings.

(60) With the attached plastic tube that Incorporates the sound being transmitted to the receiver located down in the canal. This depicts the tube that is attached to the back of the post pierced Earring Heating Aid that was presented on FIG. 1 of page 1, where it wraps around the back of the ear within the crease behind the ear and enters towards the top front portion of the ear and ear canal.

Summary of Images: The present invention of the Earring Hearing Aid was designed to be modified if necessary to offer different styles and shapes for the individual. Ear lobe jewelry, and Earring Clamp on style for cartilage ware, can vary in size and shape. Most manufactures pick a style they feel will meet their overall needs of performance.

1. Earring Hearing Aid, is orchestrated and comprising the design of an earring which houses the components that make up the actual hearing aid. The earring hearing aid is removable at user's discretion. The earring hearing aid is worn or attached to the client's lower ear lobe (lobule) or lower Pinna. The Body of the hearing aid is connected to an ear piece that transmits sound through the ear canal.

2. The Earring Hearing Aid of claim 1 offers decorative attachments that attach to the main body of the hearing aid, which may function in a dual capacity. The ornamental attachments can house the main components of the hearing as well as just be decorative and interchangeable to offer variety in color or shape.

3. The Earring Hearing Aid of claim 1 where the actual hearing aid body is designed and camouflaged by the Jewelry of the earring. The ornamental decorative unit would house the electronic and acoustic components consisting of miniature micro chips which consist of the hearing aid amplifier, microphone, battery charger/battery, input switches, Touch sound or rotating as well as tap or clap technique for volume control. Receiver, which acts as miniature loud speaker located in the ear canal. Wireless electronics and wireless communications antenna. Also the Earring Hearing Aid could encompass all elements of the components in the future and be housed all together as one unit where the receiver could also be housed in the main unit instead of the canal. The main body could be orchestrated in different shapes. Examples round, oval, square, baguette, marquise, pear shape and so on.

4. The Earring Hearing Aid of claim 1 is designed and developed for the latest in technology and future technology. Any and all electrical or energy sources. Whether it be wireless power transmission using steered phrased array antennas and time reversal properties of electromagnetic radiation to focus watts of power or beam of microwaves to a receiver module that is delivered from a central transmitter. The charger automatically locates receivers built in the devise of the earring hearing aid. Devise would stay in a state of permanent full charge mode. Could be retrofitted via add on or dongle arrangement. This technology will be offered in the future and is adaptable for the earring hearing aid. Whatever the source of power is, solar, magnetic waves, electrical or wireless of any nature the design of The Earring Hearing Aid.

5. The Earring Hearing Aid of claim 1 is attached to the client's or patent's lower portion of their ear lobe via several examples put forth here and used for ornamental earrings:
Methods of attachment include the pierced post or wire design that fits in a perforated tiny hole in lower ear lobe which can screw on to lock in place or friction nut that is adjustable. Shaped wire design, clip on clasp method, the screw clasp method and the Clamp on technique. Clip on and clamp on, also have a spring that adapts to their lower ear lobe.

6. The Earring Hearing Aid of claim 2 the user is given the option of being able to have dangling ornamental attachments that can be connected to the main body of the Earring Hearing Aid. The Dangling Attachments can also house the main components or just one or two of the components that make up the electrical or acoustic functions, or any of the other components that deliver a function that make up the of the main body of the hearing aid. Thus the dangling attachments would serve the purpose of unique design in ornamentation, as well as provide the function and the mechanics of the actual hearing aid.

7. The Earring Hearing Aid of claim 1 and 2 can offer several designs and styles of the main hearing aid body as well as different sizes, whether it is the main body that is attached to the lower ear lobe or the dangling jeweled attachments that are connected to the main earring fixture.

8. It is understood that engineers for different manufactures have developed the basic components that function as the main hearing aid and are always looking ahead in the future to improve and tweak the components where they can be housed in a smaller, and smaller housing case. In light of the above fact there are undoubtedly, many variations of the present invention are achievable. The objective set forth above, among those made apparent from the description, are efficiently attained and certain changes can be made in the above article without departing from the scope of the invention, It is understood that all matter contained in the attached description or shown in the illustrated drawings shall be interpreted and not in a limiting sense.
